(19) United States
(12) Patent Application Publication
(10) Pub. No.: US 2002/0188708 A1
(43) Pub. Date: Dec. 12, 2002

(54) Network management method and apparatus

(76) Inventors: Hiroko Takahashi, Sendai (JP); Koji Watanabe, Sendai (JP); Mitsumaro Kimura, Sendai (JP)

Correspondence Address: Rosenman & Colin LLP, 575 Madison Avenue, New York, NY, 10022-2585, US

(21) Appl. No.: 09/949,690

(22) Filed: Sep. 10, 2001

(30) Foreign Application Priority Data
Jun. 11, 2001 (JP) 2001-175833

(51) Int. Cl. G06F 15/173

(52) U.S. Cl. 709/223

(57) ABSTRACT

A network managing method automatically detects an agent apparatus even if the agent apparatus has a severe security function so that an automatic registration can be performed from the agent apparatus to a manager apparatus. A message for detection is transmitted from the manager apparatus to a plurality of agent apparatuses which constitute a network. The message for detection is given a community name for management. Automatic detection is performed according to a message for management returned from each agent apparatus. The message for management includes management information. Each agent apparatus is managed by the manager apparatus.

### BACKGROUND OF THE INVENTION

1. Field of the Invention

The present invention generally relates to a network managing method and apparatus and, more particularly, to a method and apparatus for automatically producing network management information by using a simple network management protocol (SNMP) and a manager apparatus and an agent apparatus for realizing such a method and apparatus.

2. Description of the Related Art

FIG. 1 is a functional block diagram of a conventional SNMP manager apparatus. FIG. 2 is a functional block diagram of a conventional SNMP agent apparatus.

In FIG. 1, in the SNMP manager apparatus 10, upon receipt of an automatic detection request, an automatic detection request managing part 12 inputs a community name “public”, which is provided as a default in the SNMP protocol, so as to send an automatic detection request for an SNMP agent apparatus to an SNMP protocol managing apparatus 14. Upon receipt of the automatic detection request from the automatic detection request managing part 12, the SNMP protocol managing apparatus 14 starts a communication for detecting an SNMP agent apparatus such as a node apparatus constituting a network.

Accordingly, as indicated by a communication sequence shown in FIG. 3, an SNMP manager apparatus 30 collects from an adjacent SNMP agent apparatus 32 an interface group management information base (MIB) of an interface A1. The interface A1 interfaces the SNMP agent apparatus 32 with a network which connects the SNMP manager apparatus 30 and the SNMP agent apparatus 32. An interface A2 interfaces the SNMP agent apparatus 34 with a network which connects the SNMP agent apparatus 32 and the SNMP agent apparatus 34.

Upon receipt of the communication, the SNMP agent apparatus 32 determines a community name by the community name managing part 24 shown in FIG. 2, and returns the interface group MIB of the interfaces A1 and A2 if the determined community name is “public”. The SNMP manager apparatus 30 shown in FIG. 3 performs a communication to collect the IP group MIB of the interface A2 based on the received information. Upon receipt of the communication, the SNMP agent apparatus 32 checks the community name, and returns the interface group MIB of an interface B1 of an adjacent SNMP agent apparatus 34. The SNMP manager apparatus 30 collects information regarding the interfaces B1 and B2 by the same sequence as that of the collection of the information regarding the interfaces A1 and A2.

In the conventional SNMP manager apparatus 30, an operator manually registers the SNMP agent apparatus used as a candidate for management and manually produces a screen of a network composition. For this reason, the operator must check information regarding each node and a network composition, and, thus, there is a problem of taking time and effort very much.

Moreover, in order to detect the node apparatus as an SNMP agent apparatus used as a candidate for management, the SNMP manager apparatus 30 performs communication with the node apparatus using the default community name “public” in the SNMP protocol. Accordingly, there is a case in which the node apparatus having a severe security function cannot return the management information which the SNMP manager apparatus 30 requires. In such a case, there is a problem in that the automatic detection cannot be performed.

Moreover, in the Internet Protocol version 4 (IPv4), there is a problem in that there is no automatic registration means from the SNMP agent apparatus to the SNMP manager apparatus when the SNMP agent apparatus (node apparatus) used as a candidate for network management is added to the network.

### SUMMARY OF THE INVENTION

It is a general object of the present invention to provide an improved and useful network managing method and apparatus in which the above-mentioned problems are eliminated.

A more specific object of the present invention is to provide a network managing method and apparatus which can automatically detect an agent apparatus even if the agent apparatus has a severe security function so that an automatic registration can be performed from the agent apparatus to a manager apparatus.

In order to achieve the above-mentioned objects, there is provided according to one aspect of the present invention a network management method comprising the steps of: transmitting a message for detection from a manager apparatus to a plurality of agent apparatuses which constitute a network, the message for detection being given a community name for management; performing automatic detection according to a message for management returned from each agent apparatus, the message for management including management information; and managing each agent apparatus by the manager apparatus.

According to the above-mentioned invention, since the community name for management is given to the message for detection which is transmitted from the manager apparatus to the agent apparatuses. Accordingly, if one of the agent apparatuses has a severe security function, such agent apparatus can be automatically detected and management information can be created.

The above-mentioned network management method may further comprise a step of sending a message for registration of management information from the agent apparatuses to the manager apparatus, the message for registration being given the community name for management. Accordingly, the management information can be automatically registered from a newly added agent apparatus to the manager apparatus.

Additionally, the network management method may further comprising a step of registering and managing the community name for management to be given to the message for registration together with an identifier of each agent apparatus. Accordingly, even if an identifier of one of the agent apparatuses is no known, the manager apparatus can discriminate the one of the agent apparatuses by referring to the unique community name for registration and can register the management information.

Additionally, there is provided according to another aspect of the present invention an agent apparatus constituting a network and being managed by a manager apparatus, comprising: an automatic detection managing part which receives a message for detection and returns a message for management including management information to the manager apparatus, wherein the message for detection is given a community name for management which is transmitted from the manager apparatus, and the massage for management is given the community name for management.

According to the above-mentioned invention, if one of the agent apparatuses has a severe security function, such agent apparatus can be automatically detected and management information can be created.

The agent apparatus according to the present invention may further comprise an automatic registration managing part which transmits a message for registration used for registering management information to the manager apparatus, wherein the message for registration is given the community name for management. Accordingly, the management information can be automatically registered from a newly added agent apparatus to the manager apparatus.

Additionally, there is provided according to another aspect of the present invention a manager apparatus for managing a plurality of agent apparatuses constituting a network, comprising: an automatic detection managing part which transmits a message for detection to each agent apparatus so as to cause each agent apparatus to return a message for management including management information, wherein the message for detection is given the community name for management.

According to the above-mentioned invention, if one of the agent apparatuses has a severe security function, such agent apparatus can be automatically detected and management information can be created.

The manager apparatus according to the present invention may further comprise an automatic registration managing part which receives a message for registration transmitted from each agent apparatus and registers the management information included in the message for registration, the massage for registration having the community name for management. Accordingly, the management information can be automatically registered from a newly added agent apparatus to the manager apparatus.

Additionally, the manager apparatus may further comprise a network composition display managing part which receives the message for registration from the agent apparatuses and displays a network composition in accordance with the management information included in the message for registration. Accordingly, an updated network composition can be displayed when a new agent apparatus is added to the network.

The network composition display managing part may display the network composition according to a designated display level, and, thereby, the range of display of the network composition can be arbitrarily designated by an operator. Additionally, the automatic detection managing part may detect the agent apparatuses within a designated range for searching, and, thereby, the agent apparatuses within the designated range can be detected at a high speed. Further, the automatic detection managing part may perform a detection of the agent apparatuses within a designated time period, and, thereby, the detection of the agent apparatuses within the designated range for searching can be efficiently performed at a higher speed.

Other objects, features and advantages of the present invention will become more apparent from the following detailed description when read in conjunction with the accompanying drawings.

### BRIEF DESCRIPTION OF THE DRAWINGS

FIG. 1 is a functional block diagram of a conventional SNMP manager apparatus;

FIG. 2 is a functional block diagram of a conventional SNMP agent apparatus;

FIG. 3 is an illustration showing a communication sequence of the SNMP manager apparatus and the SNMP agent apparatus;

FIG. 4 is a functional block diagram of an example of an SNMP manager apparatus according to a first embodiment of the present invention;

FIG. 5 is a functional block diagram of an example of an SNMP agent apparatus according to the first embodiment of the present invention;

FIG. 6 is an illustration showing an Internet Protocol (IP) network of a first embodiment of a transmission network to which a method according to the present invention is applied;

FIG. 7 is an illustration of the composition of the SNMP protocol message for automatic detection;

FIG. 8 is a flowchart of a process which a community name managing part performs at the time of automatic detection of the SNMP agent apparatuses in the SNMP manager apparatus;

FIG. 9 is a flowchart of a process which the community name managing part performs at the time of automatic registration of the SNMP agent apparatuses in the SNMP manager apparatus;

FIG. 10 is a flowchart of a process performed by the automatic detection managing part in the SNMP manager apparatus;

FIG. 11 is a flowchart of a process which is performed by the automatic registration managing part 48 in the SNMP manager apparatus;

FIG. 12 is a flowchart of a process which is performed by a network composition display managing part in the SNMP manager apparatus;

FIG. 13 is a flowchart of a process which is performed by a community name managing part in the SNMP agent apparatus;

FIG. 14 is a flowchart of a process performed by an automatic detection managing part in the SNMP agent apparatus;

FIG. 15 is a flowchart of a process which is performed by an automatic registration managing part in the SNMP agent apparatus;

FIG. 16 is an illustration of a composition of the SNMP protocol message for automatic registration;

FIG. 17 is a flowchart of a process which is performed by the automatic registration managing part in the SNMP manager apparatus;

FIG. 18 is a functional block diagram of an example of an SNMP manager apparatus according to a second embodiment of the present invention;

FIG. 19 is an illustration of contents of a display level management list;

FIG. 20 is a flowchart of a process which is performed by a network composition display managing part in the SNMP manager apparatus shown in FIG. 18;

FIG. 21 is an illustration showing an Internet Protocol (IP) network of a second embodiment of the transmission network to which a method according to the present invention is applied;

FIG. 22 is an illustration for explaining a searching operation when an automatic search is performed by designating one domain by the SNMP manager apparatus according to the present invention;

FIG. 23 is an illustration showing a composition of the net management system to which the method according to the present invention is applied; and

FIG. 24 is an illustration showing a community name list for registration managed by a registration community name management server apparatus.

### DETAILED DESCRIPTION OF THE PREFERRED EMBODIMENTS

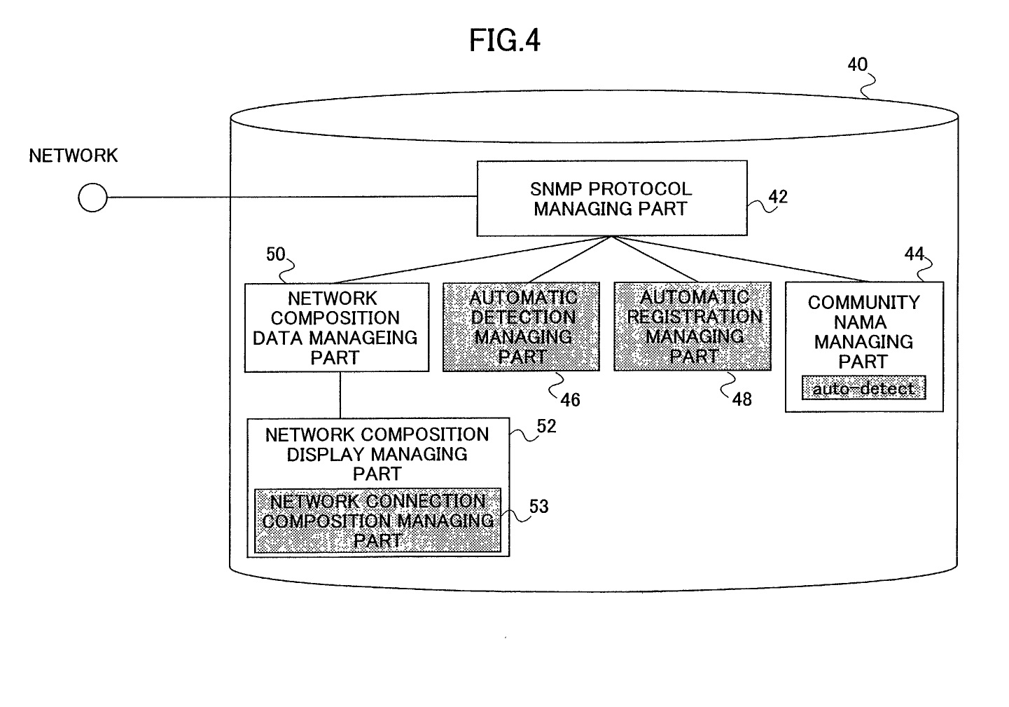

FIG. 4 is a functional block diagram of an example of an SNMP manager apparatus according to a first embodiment of the present invention. As shown in FIG. 4, the SNMP manager apparatus 40 comprises: an SNMP protocol managing part 42 which manages an SNMP protocol; a community name managing part 44 which manages a community name and has a community name “auto-detect” for management; an automatic detection managing part 46 which performs automatic detection of the SNMP agent apparatus by the SNMP manager apparatus; an automatic registration managing part 48 which registers SNMP apparatus upon reception of an automatic registration request from the SNMP agent apparatus; a network composition data managing part 50 which manages network composition data; and a network composition display managing part 52 which manages by the network connection composition managing part 53 the connection of a group of SNMP agent apparatuses based on data stored in the network composition data managing part 50, and displays connection composition of the group of the SNMP agent apparatuses.

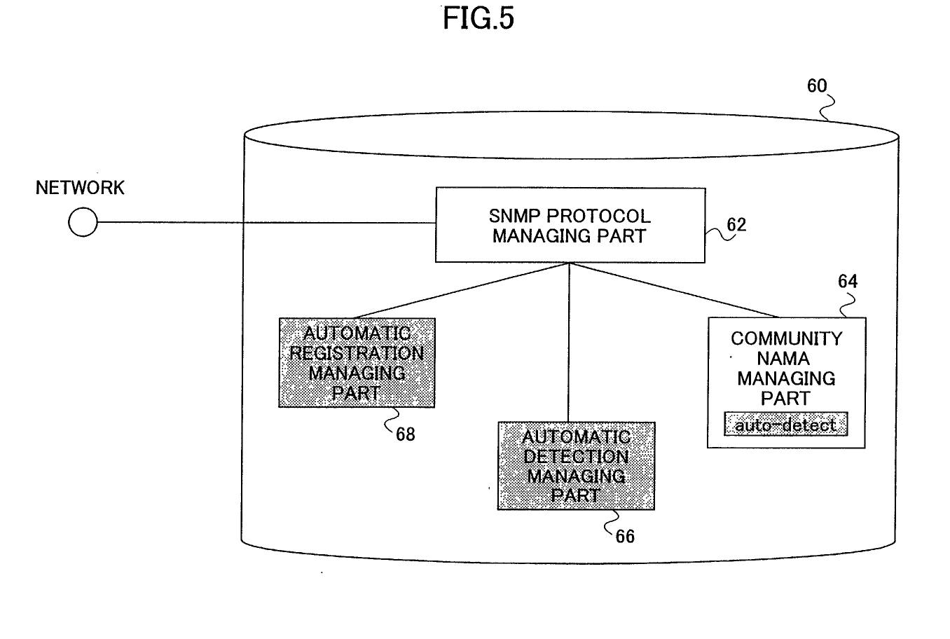

FIG. 5 is a functional block diagram of an example of an SNMP agent apparatus according to the first embodiment of the present invention. As shown in FIG. 5, the SNMP agent apparatus 60 comprises: an SNMP protocol managing part 62 which manages an SNMP protocol, a community name managing part 64 which manages a community name and has a community name “auto-detect” for management; an automatic detection managing part 66 which responds to the automatic detection of the SNMP agent apparatus by the SNMP manager apparatus; and the automatic registration managing part 68 which sends an automatic registration request to the SNMP agent apparatus.

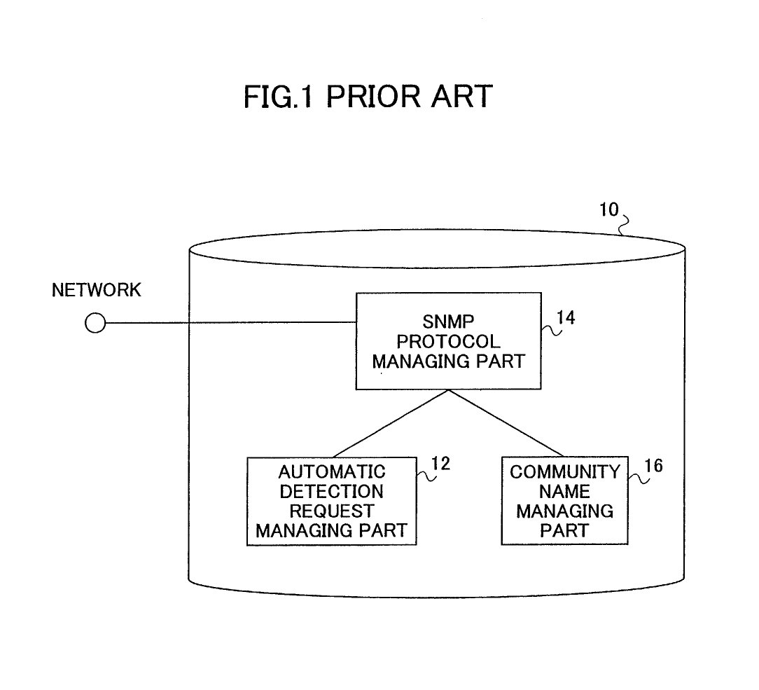

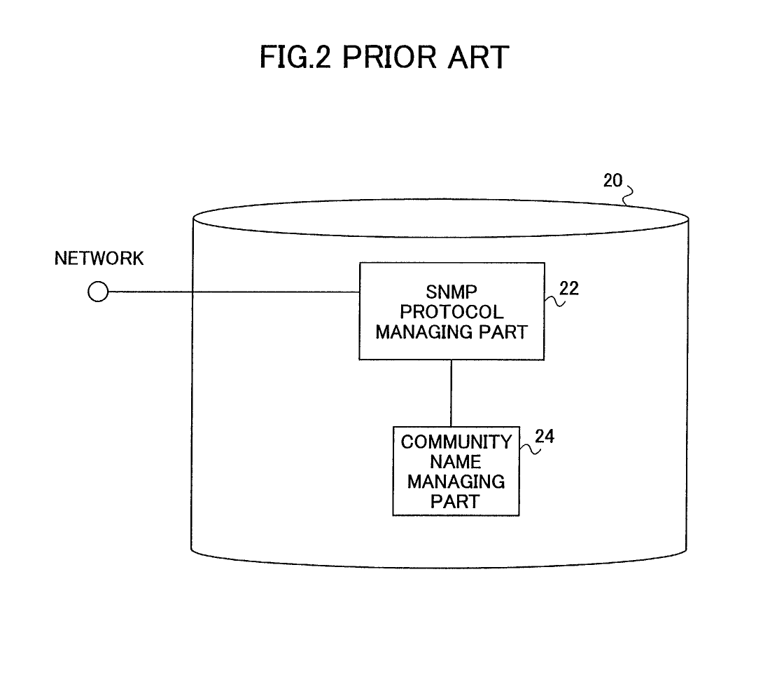

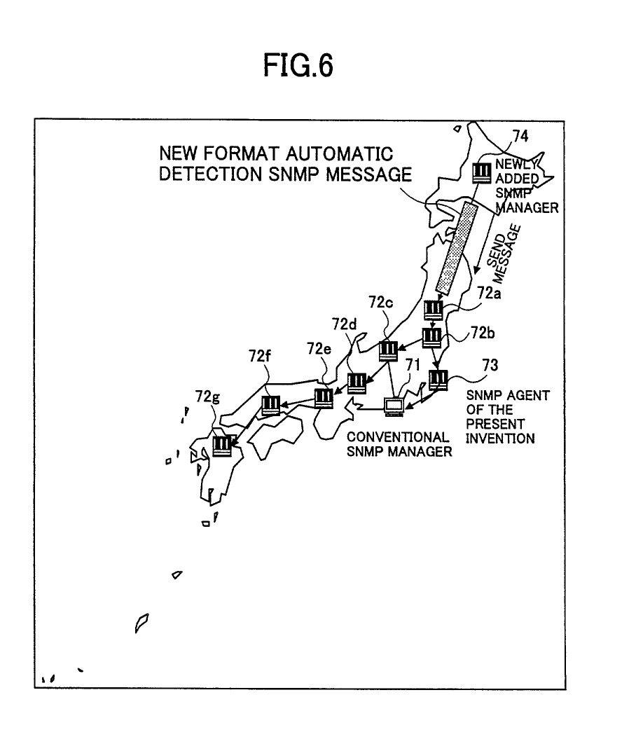

FIG. 6 is an illustration showing an Internet Protocol (IP) network of a first embodiment of a transmission network to which a method according to the present invention is applied. FIG. 6 shows a network composition when the SNMP manager apparatus according to the present invention is newly added. In FIG. 6, the SNMP manager apparatus 71 corresponds to the conventional SNMP manager apparatus shown in FIG. 1. Moreover, the SNMP agent apparatuses 72a-72g correspond to the conventional SMNP agent apparatuses shown in FIG. 2. An SNMP agent apparatus 73 is the SNMP agent apparatus according to the present invention shown in FIG. 5, which SNMP agent apparatus is connected to the IP network. An SNMP manager apparatus 74 is the SNMP manager apparatus according to the present invention shown in FIG. 4, which is newly added to the IP network.

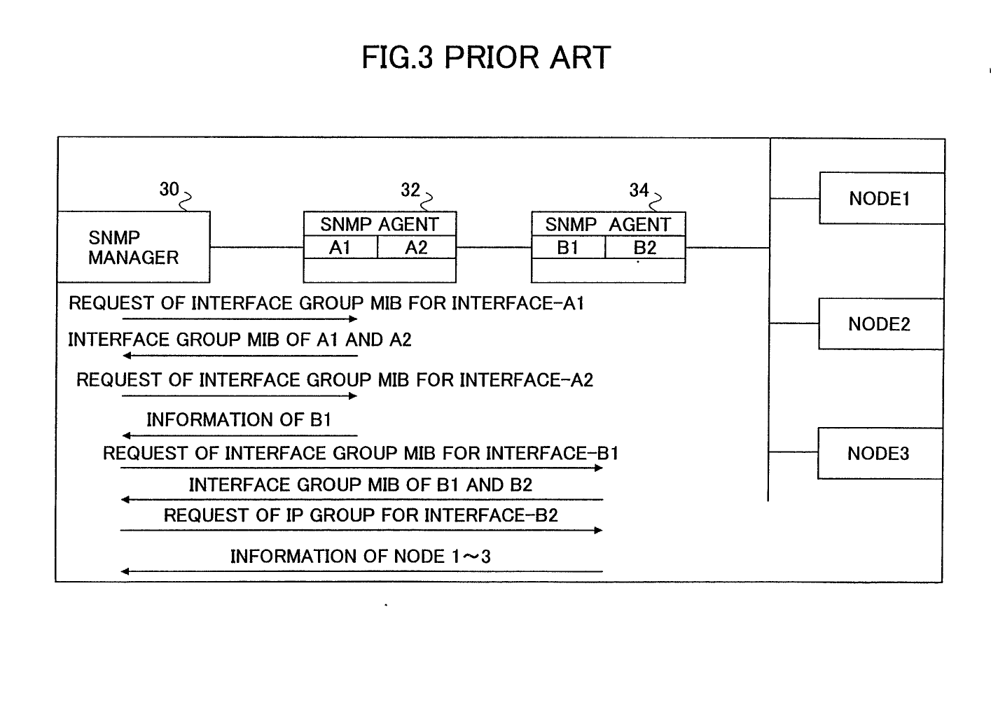

The SNMP manager apparatus 74 connected to the IP network performs automatic detection of the SNMP agent apparatuses using an SNMP protocol message of a new format which uses the community name “auto-detect” added by the present invention. In this case, as shown in the communication sequence of FIG. 3, the SNMP manager apparatus 30 (corresponds to the added SNMP manager apparatus 74) collects the interface group MIB of an interface A1 by the SNMP protocol message of the community name “auto-detect” from adjacent SNMP agent apparatus 32 (corresponds to 72a). Next, the SNMP agent apparatus 32, which received the communication from the SNMP manager apparatus 30, returns the interface group MIB of the interfaces A1 and A2. Next, the SNMP manager apparatus 30, to which the MIB information was returned from the SNMP agent apparatus 32, collects the interface group MIB of the interface A2 of the SNMP agent apparatus 32 in accordance with the SNMP protocol message having the community name “auto-detect”. Next, the SNMP agent apparatus 32, which received the communication from the SNMP manager apparatus 30, returns the interface B1 information regarding the SNMP agent apparatus 34 connected to the interface A2. Moreover, the SNMP agent apparatus 32 checks a community name by the community name managing part 64, and returns the interface group MIB of the interface B1 of the SNMP agent apparatus 34.

The SNMP manager apparatus 40 shown in FIG. 4 automatically detects the SNMP agent apparatuses from 72a to 72g shown in FIG. 6 by using the above-mentioned communication sequence. After the SNMP agent apparatuses from 72a to 72g are detected, the detecting operation of the SNMP agent apparatus is stopped when there is no information returned from the SNMP agent apparatus 72g, or when the network has not been connected after the return of the information by judging from the IP address of the returned information. The network composition data of all the SNMP agent apparatuses collected by the SNMP manager apparatus 40 is held by the network composition data managing part 50. The network connection composition managing part 53 creates a network connection composition map based on the network composition data currently held by the network composition data managing part 50, and displays the map by the network composition display managing part 52.

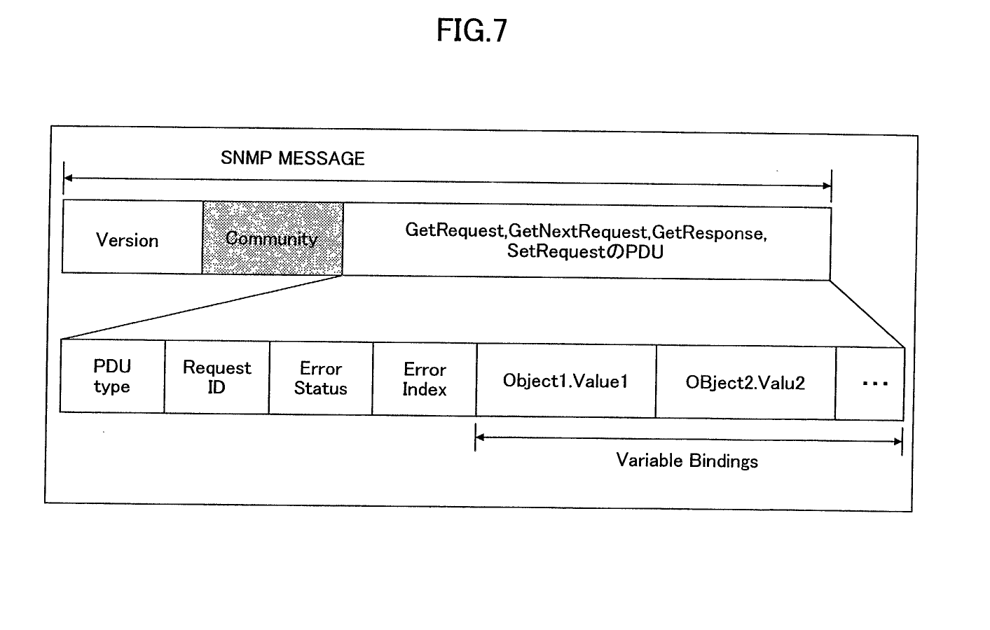

FIG. 7 is an illustration of the composition of the SNMP protocol message for automatic detection. In the message, a protocol data unit (PDU) is provided subsequent to a version identifier (Version) and a community (Community). Although the community name of the conventional SNMP protocol message is “public”, the community name of the SNMP protocol message according to the present invention is “auto-detect”. The PDU field includes a PDU type, a request ID, an error status, an error index and a variable binding field.

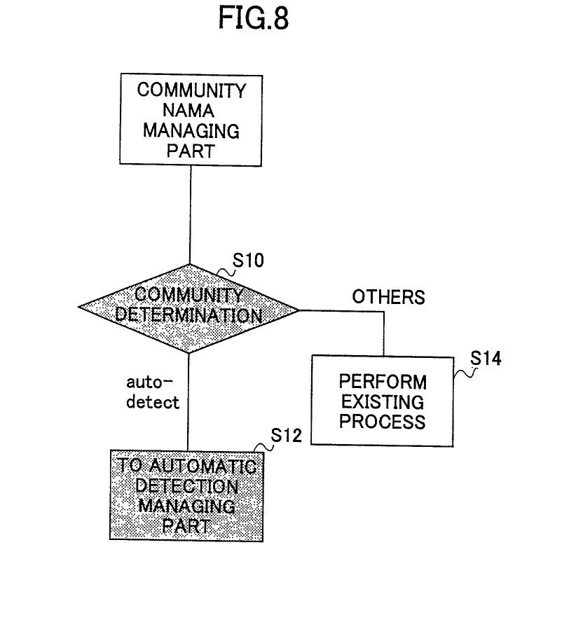

FIG. 8 is a flowchart of a process which the community name managing part 44 performs at the time of the automatic detection of the SNMP agent apparatuses in the SNMP manager apparatus 40. In FIG. 8, the community name received from the SNMP protocol managing part 42 is compared, in step S10, with the community name “auto-detect” for management. If the received community name and the community name “auto-detect” for management match, the routine proceeds to step S12 to carry out the process of the automatic detection managing part 46. If they do not match, i.e., when the community name is “public”, the routine proceeds to step S14 to shift to the existing process.

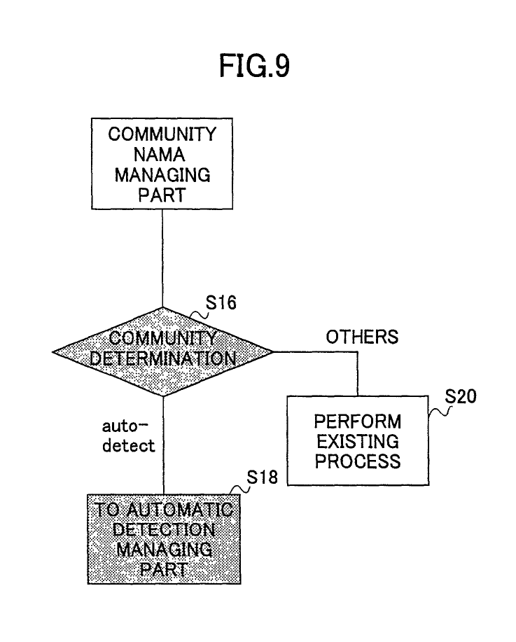

FIG. 9 is a flowchart of a process which the community name managing part 44 performs at the time of the automatic registration of the SNMP agent apparatuses in the SNMP manager apparatus 40. In FIG. 9, the community name received from the SNMP protocol managing part 42 is compared, in step S16, with the community name “auto-detect” for management. If the received community name and the community name “auto-detect” for management match, the routine proceeds to step S18 to carry out the process of the automatic registration managing part 48. If they do not match, i.e., when the community name is “public”, the routine proceeds to step S20 to shift to the existing process.

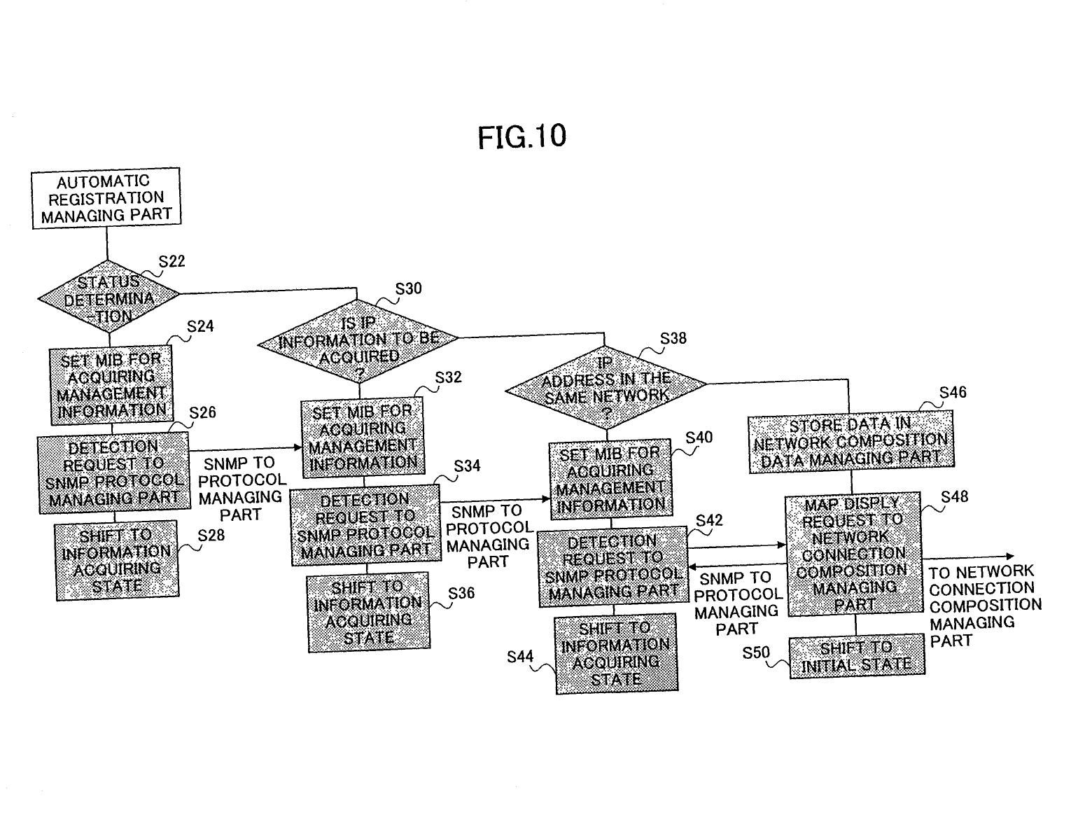

FIG. 10 is a flowchart of a process performed by the automatic detection managing part 46 in the SNMP manager apparatus 40. In FIG. 10, it is determined, in step S22, whether or not the SNMP manager apparatus 40 is in an initial state. If it is in the initial state, MIB is set up in step S24 so as to send a request (get request) for acquiring management information (interface group MIB) to an adjacent SNMP agent apparatus. Then, an automatic detection request is sent to the SNMP protocol managing part 42 in step S26. Thereafter, the apparatus shifts, in step S28, to an information acquiring state. At this time, a community name “auto-detect” is set as a community name according to the SNMP protocol message shown in FIG. 7. In subsequent communications, all SNMP protocol messages will have the same message composition.

On the other hand, if it is determined, in step S22, that the apparatus is not in the initial state, it is determined, in step 30, whether or not the apparatus is in the information acquiring state and the received information is the interface group MIB. If the determination is affirmative, MIB for making a request (get request) for acquiring management information (IP group MIB) is set up in step S32. Then, an automatic detection request is given to the SNMP protocol managing part 42 in step S34, and the apparatus shifts to the information acquiring state in step S36.

On the other hand, if the information received in step S30 is not the interface group MIB, it is determined whether or not it is the address of the same network, that is, whether subsequent networks exist by referring to the contents of the IP group MIB acquired in step S38. When subsequent networks exist, the interface group MIB are collected, in steps S40 to S44, from the SNMP agent apparatus similar to the process of steps S24 to S28.

On the other hand, if subsequent networks do not exist, all the data acquired in step S46 is handed over and stored in the network composition data managing part 50. A display request of a map is given to the network connection composition managing part 53 in step S48 after the storage of the data, and the apparatus shifts to the initial state in step S50.

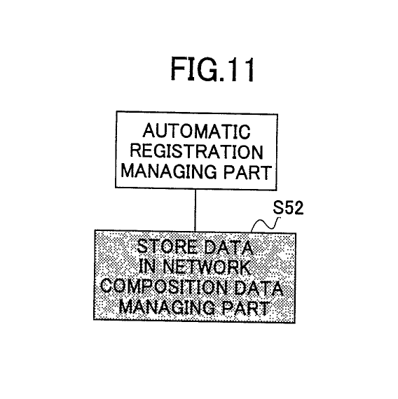

FIG. 11 is a flowchart of a process which is performed by the automatic registration managing part 48 in the SNMP manager apparatus 40. In FIG. 11, the automatic registration managing part 48 started by the community name managing part 44 hands over and stores in the network composition data managing part 50 the network composition data received in step S52.

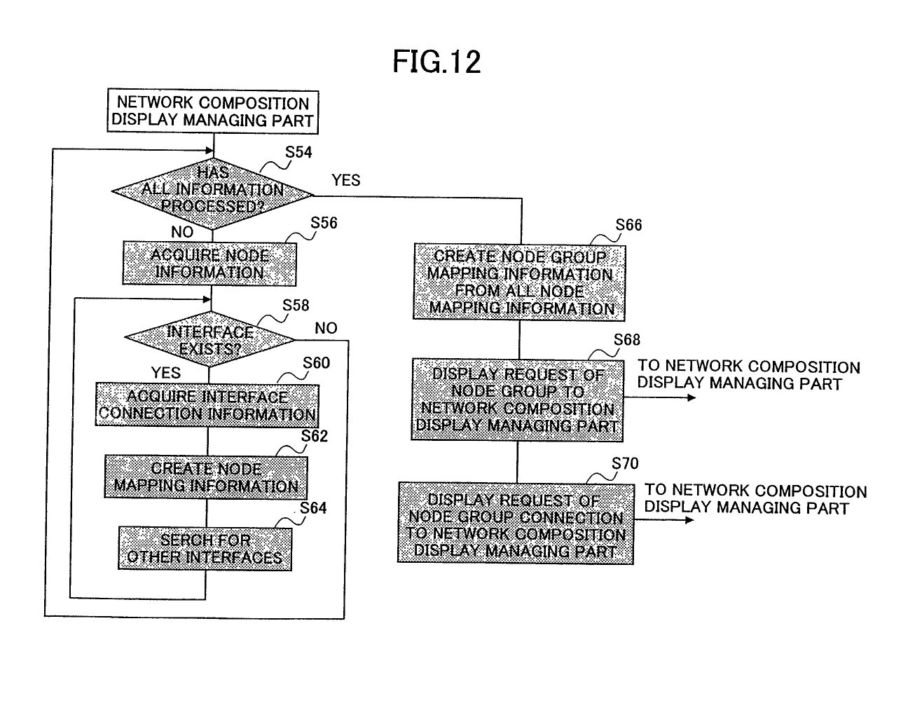

FIG. 12 is a flowchart of a process which is performed by the network composition display managing part 52 in the SNMP manager apparatus. In FIG. 12, the network connection composition managing part 53 started by the automatic detection managing part 46 determines, in step S54, whether or not all information has been processed. If all information has not been processed, node information stored in the network composition data managing part 50 is acquired in step S56. Next, it is determined, in step S58, whether or not there is any interface based on the node information. If there is an interface, interface connection information is acquired in step S60. After creating node mapping information in step S62, the mapping information regarding each node apparatus is created by searching, in step S64, other interfaces from the node information concerned, and progressing to step S58. If it is determined, in step S58, that there is no interface, the routine proceeds to step S54. If is it determined, in step S54, that all information has been processed, the routine proceeds to step S66. In step S66, the mapping information regarding a node group is created based on the mapping information regarding each node apparatus. Thereafter, a node group display request and a node group connection display request are sent to the network composition display managing part 52 in steps S68 and S70.

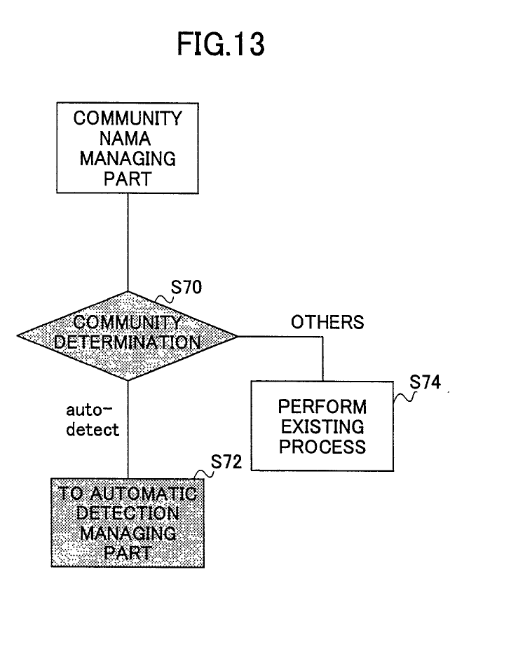

FIG. 13 is a flowchart of a process which is performed by the community name managing part 64 in the SNMP agent apparatus 60. In FIG. 13, the community name managing part 64 compares, instep S70, the community name received from the SNMP protocol managing part 62 with the community name “auto-detect” for management. If the received community name and the community name “auto-detect” for management match, the routine proceeds to the process of the automatic detection managing part 66 in step S72. If the received community name and the community name “auto-detect” for management do not match, i.e., when a community name is “public”, the routine proceeds to step S74 to perform the existing process.

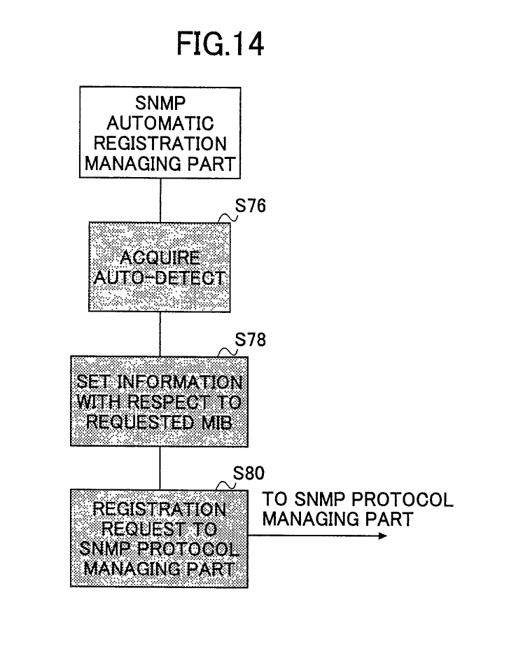

FIG. 14 is a flowchart of a process performed by the automatic detection managing part 66 in the SNMP agent apparatus 60. In FIG. 14, the automatic detection managing part 66 started by the community name managing part 64 acquires, in step S76, the SNMP protocol message of the community name “auto-detect”. The automatic detection managing part 66 checks, in step S78, MIB in an SNMP protocol message and sets up the corresponding information. The automatic detection managing part 66 gives, in step S80, a management information return request to the SNMP protocol managing part 62. The community name “auto-detect” is set in the community (Community) of the SNMP protocol message composition for automatic detection shown in FIG. 7.

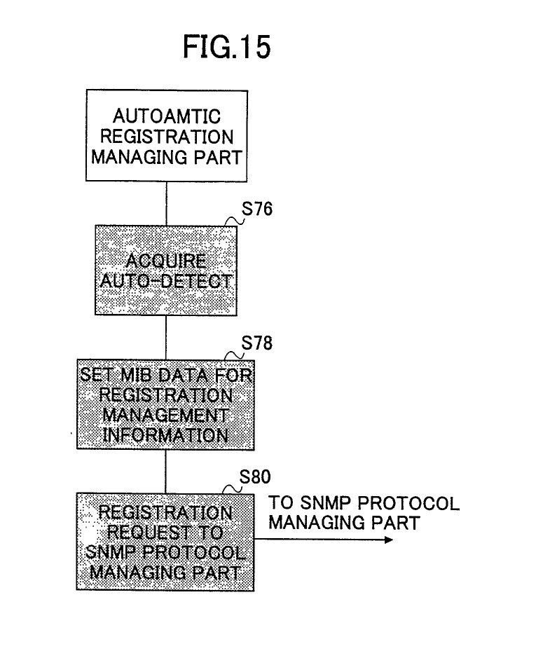

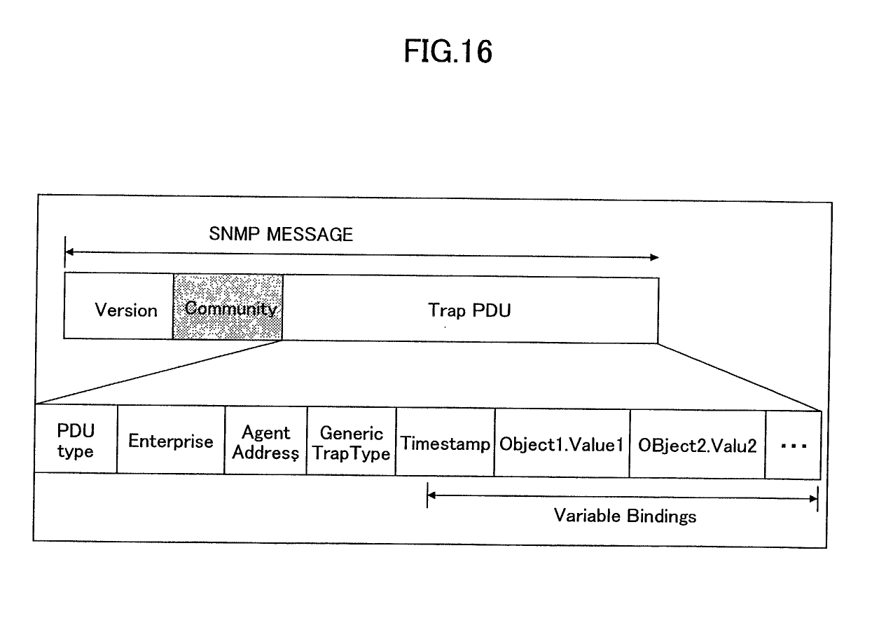

FIG. 15 is a flowchart of a process which is performed by the automatic registration managing part 68 in the SNMP agent apparatus 60. In FIG. 15, the automatic registration managing part 68 started by the community name managing part 64 acquires the SNMP protocol message of the community name “auto-detect” in step S82. The automatic registration managing part 68 sets up, in step 84, the management information which registers, and sends a management information registration request to the SNMP protocol managing part 62 in step S86. The community name “auto-detect” is set in the community (Community) of the SNMP protocol message composition for automatic registration shown in FIG. 16. FIG. 16 is an illustration of a composition of the SNMP protocol message for automatic registration. In the message, a protocol data unit (PDU) is provided subsequent to a version identifier (Version) and a community (Community). Although the community name of the conventional SNMP protocol message is “public”, the community name of the SNMP protocol message of the present invention is “auto-detect”. The PDU field includes a PDU type, an enterprise, an agent address of a transmitting agency, a generic trap type, a specific trap type, a time stamp and a variable binding field.

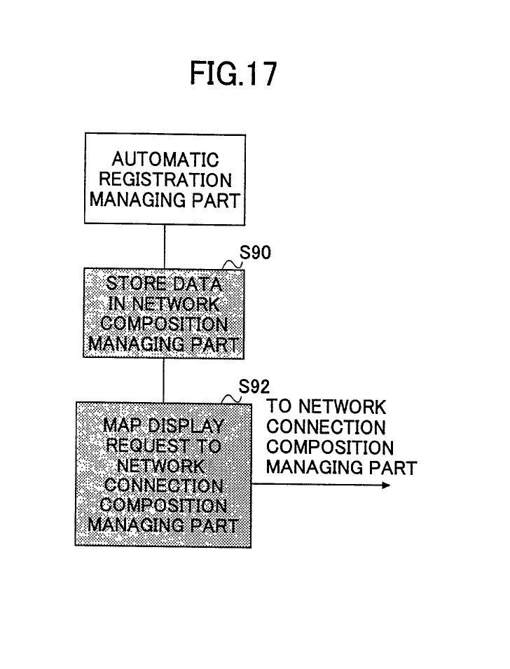

FIG. 17 is a flowchart of a process which is performed by the automatic registration managing part 48 in the SNMP manager apparatus 40. In FIG. 17, the automatic registration managing part 48, which received the automatic registration request from the SNMP agent apparatus, stores network composition data in the network composition data managing part 50 in step S90, and gives a map display request to the network connection composition managing part 53 in step S92. Thereby, a network connection composition map can be updated by the request from the SNMP agent apparatus.

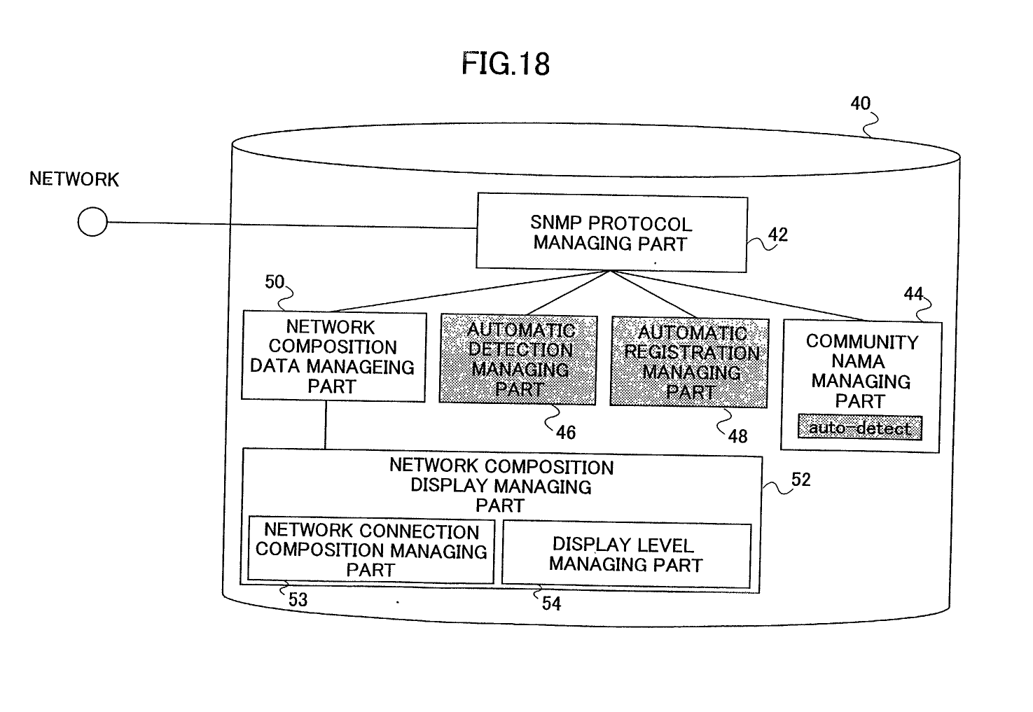

A description will now be given of a second embodiment of the present invention. FIG. 18 is a functional block diagram of an example of an SNMP manager apparatus according to the second embodiment of the present invention. In FIG. 18, parts that are the same as the parts shown in FIG. 4 are given the same reference numerals, and descriptions thereof will be omitted.

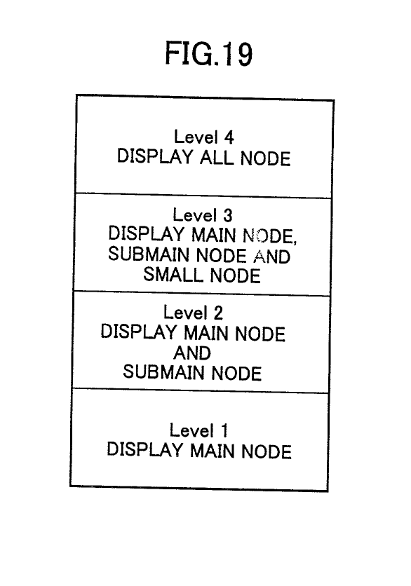

In FIG. 18, a display level managing part 54 is provided in a network composition display managing part 52. A display level management list as shown in FIG. 19 is previously stored in the display level managing part 54. A level 1 specifies the display of the main node apparatus in the IP network, and a level 2 specifies the display of the main node apparatus and a submain node apparatus in the IP network. Moreover, a level 3 specifies the display of the main node apparatus, a submain node apparatus and a small node apparatus in the IP network, and a level 4 specifies the display of all the node apparatuses in the IP network. The network connection composition managing part 53 creates a network connection composition map based on the network composition data currently held by the network composition data managing part 50. The map is displayed by the network composition display managing part 52.

When a network connection composition map is displayed in the SNMP manager apparatus 40 at this time, an arbitrary display level (either of the levels 1-4) is set up by an operator. Thereby, node apparatuses in the range corresponding to the display level set up by the operator are displayed from a display level management list. Accordingly, customization of the contents of a display can be achieved, and the network composition which the maintenance person intends can be displayed.

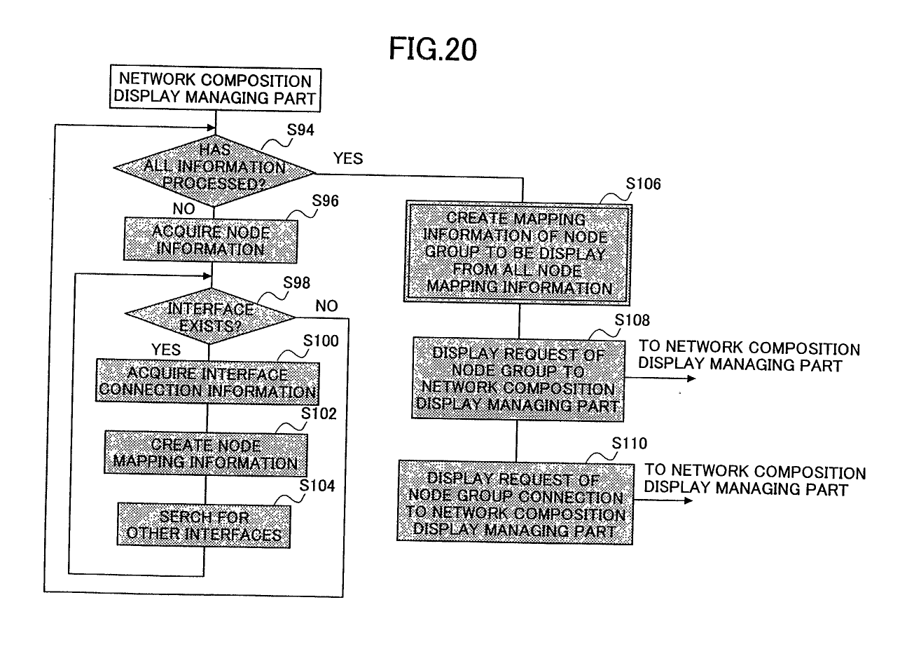

FIG. 20 is a flowchart of a process which is performed by the network composition display managing part 52 in the SNMP manager apparatus 40 shown in FIG. 18. In FIG. 20, the network connection composition managing part 53 started by the automatic detection managing part 46 determines, in step S94, whether or not all information has been processed. If all information has not been processed, the node information stored in the network composition data managing part 50 is acquired in step S96. Thereafter, it is determined, in step S98, whether or not there is any interface based on the node information. If there is an interface, interface connection information is acquired in step S100. Then, node mapping information is created in step S102, and the mapping information regarding each node apparatus is created by searching other interfaces in step S104 from the node information concerned and progressing to step S98. If it is determined, in step S98, that there is no interface, the routine returns to step S94. If it is determined, in step S94, that all information has not been processed, the routine proceeds to step S106. In step S106, the node apparatus to be displayed, which is set by comparing with the display level management list of FIG. 19, is extracted from the system MIB in the network composition data. Then, based on the mapping information regarding the extracted node apparatus, the mapping information regarding the node group to be displayed is created, and a node group display request and a node group connection display request are given to the network composition display managing part 52 in steps S108 and S110. Thereby, the operator is able to arbitrarily set up the display range of network composition.

A description will now be given of a third embodiment of the present invention.

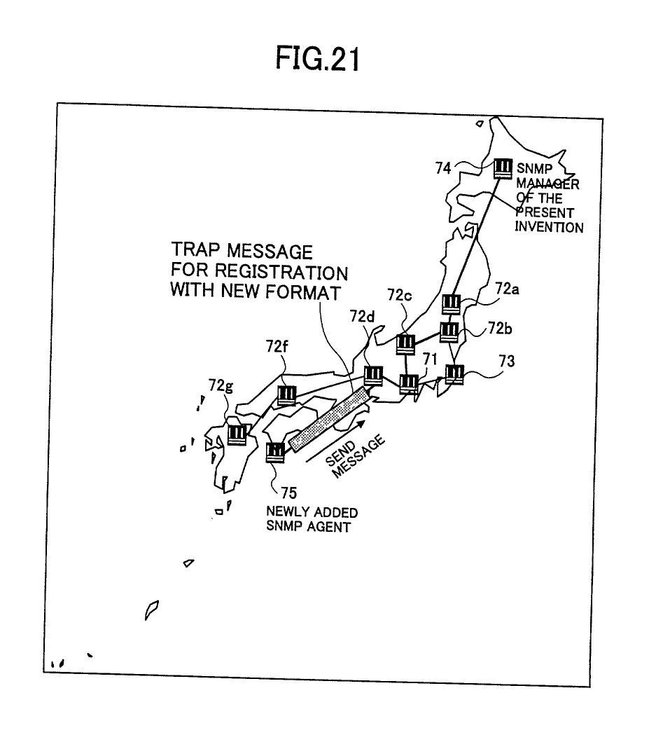

FIG. 21 is an illustration showing an Internet Protocol (IP) network of a second embodiment of the transmission network to which a method according to the present invention is applied. FIG. 21 shows the network composition when the SNMP agent apparatus according to the present invention is newly added. In FIG. 21, an SNMP manager apparatus 71 corresponds to the conventional SNMP manager apparatus shown in FIG. 1, and the SNMP agent apparatuses 72a-72g correspond to conventional SNMP agent apparatuses shown in FIG. 2. An SNMP agent apparatus 73 is the SNMP agent apparatus according to the present invention shown in FIG. 5, which has been connected to the IP network. An SNMP manager apparatus 74 is the SNMP manager apparatus according to the present invention shown in FIG. 4, which is newly added to the IP network. An SNMP agent apparatus 75 is the SNMP agent apparatus according to the present invention shown in FIG. 5, which is newly added to the IP network. The SNMP agent apparatus 75 connected to the IP network makes an automatic registration request to the SNMP manager apparatus 74 using the SNMP protocol message of the new format shown in FIG. 16 which uses the community name “auto-detect” added by the present invention. The SNMP manager apparatus 74, which received the automatic registration request from the SNMP agent apparatus 75 holds the network composition data for automatic registration. When a registration request is sent to the SNMP manager apparatus 74, the contents of registration are automatically reflected in a network connection composition map, and a network connection composition map is updated.

A description will now be given of a fourth embodiment of the present invention.

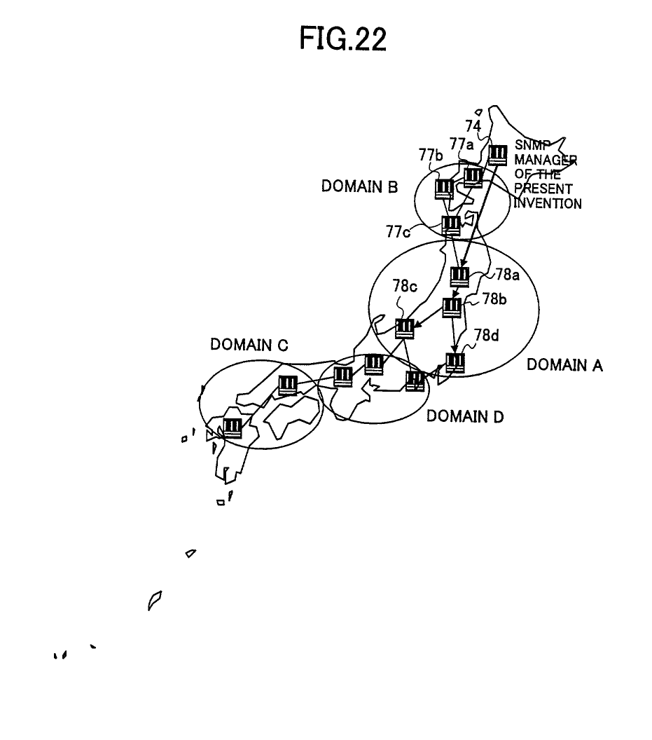

FIG. 22 is an illustration for explaining a searching operation when an automatic search is performed by designating a domain A by the SNMP manager apparatus according to the present invention. In FIG. 22, a plurality of domains A, B, C, etc. exist on the network. In addition, the SNMP agent apparatuses of domains A, B and C are assumed to be the SNMP agent apparatus according to the present invention shown in FIG. 5. Although the SNMP manager apparatus 74 according to the present invention is connected to the SNMP agent apparatus 77a of the domain B, the SNMP manager equipment 74 according to the present invention disregards the SNMP protocol message returned by the automatic search from the SNMP agent apparatuses 77a-77c of the domain B since the domain A is designated for the SNMP manager apparatus 74.

Next, the SNMP manager apparatus 74 acquires the SNMP protocol message returned from the SNMP agent apparatuses 78a-78d of the domain A. Thereafter, the search of the network is ended when an SNMP protocol message is returned from an SNMP agent apparatus of a domain D other than the domain A. Accordingly, the SNMP agent apparatus of the designated searching range is detectable at a high speed.

Moreover, the SNMP manager apparatus 74 has a function to set up a maximum time after starting an automatic search until one SNMP agent apparatus is discovered in the domain A, and also has a function to set up a maximum time after discovering one SNMP agent apparatus until the search of the domain A is ended. Thereby, it becomes possible to perform an efficient automatic search at a higher speed.

A description will now be given of a fifth embodiment of the present invention.

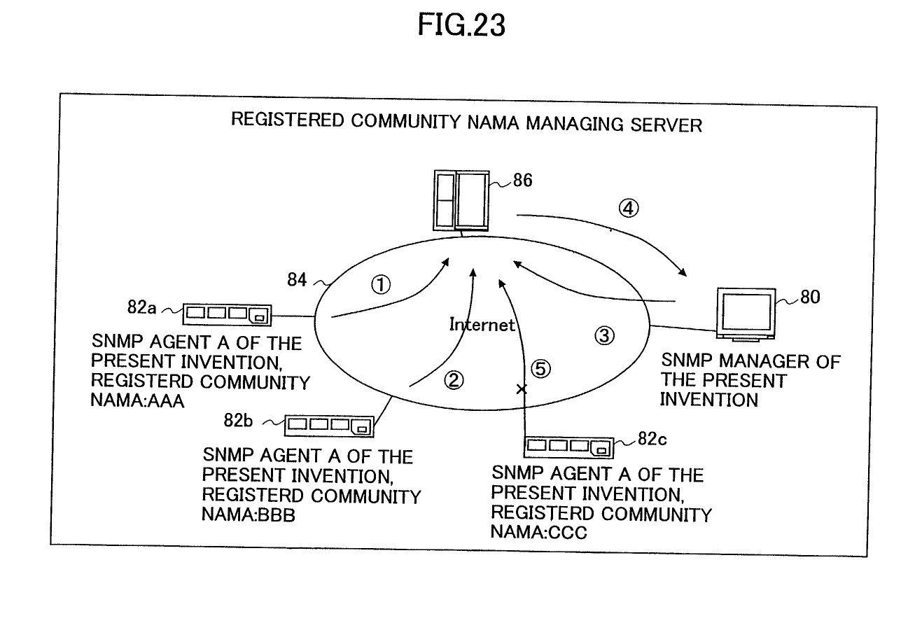

FIG. 23 is an illustration showing a composition of the net management system to which the method according to the present invention is applied. In FIG. 23, an SNMP manager apparatus 80 corresponds to the SNMP manager apparatus according to the present invention shown in FIG. 4. The SNMP agent apparatuses 82a-82c correspond to the SNMP agent apparatuses according to the present invention shown in FIG. 5. The SNMP manager apparatus 80 and the SNMP agent apparatuses 82a-82c are connected to a registration community name management server apparatus 86 through the Internet 84.

The SNMP agent apparatus 82a requests the registration community name management server apparatus 86 to make a registration of the community name for registration “AAA”. Thus, the registration community name management server apparatus 86 registers the community name “AAA”, which is requested to be registered, together with SysObjecID of the SNMP agent apparatus 82a (1). SysobjecID is an identification number which each apparatus has individually. The number in a parenthesis corresponds to a number with a circle provided to an arrow shown in FIG. 23.

Next, the SNMP agent apparatus 82b requests the registration community name management server apparatus 86 to make a registration of the community name for registration “BBB”. Thus, the registration community name management server apparatus 86 registers the community name “BBB”, which is requested to be registered, together with SysObjecID of the SNMP agent apparatus 82b (2). Thereafter, the SNMP agent apparatus 82c requests the registration community name management server apparatus 86 to make a registration of the community name for registration “AAA”. However, since the community name “AAA”, which is requested to be registered, is already registered by the SNMP agent apparatus 82a, the registration community name management server apparatus 86 refuses this registration (5). It should be noted that, when a registration is refused, a response to that effect is returned to the SNMP agent apparatus 82c. Thereby, the SNMP agent apparatus 82c requests a registration again by other community names for registration.

The SNMP manager apparatus 80 inquires the registration community name management server apparatus 86 about the community name for registration corresponding to SysObjectID of the SNMP agent apparatus to be searched for (3). In response to the inquiry, if a registration has been made, the registration community name management server apparatus 86 notifies the SNMP manager apparatus 80 of the community name for registration corresponding to SysObjectID of the SNMP agent apparatus to be searched for (4). Then, if an SNMP protocol message is sent from the SNMP agent apparatus to be searched for to the SNMP manager apparatus 80 using the community name for registration, an automatic registration can be performed since the SNMP manager apparatus 80 has recognized the community name for registration concerned. That is, even if SysObjectID (identifier) of the SNMP agent apparatus is not given to the SNMP manager apparatus 80, the SNMP manager apparatus 80 can discriminate an agent apparatus from the original community name for registration, and can register the management information.

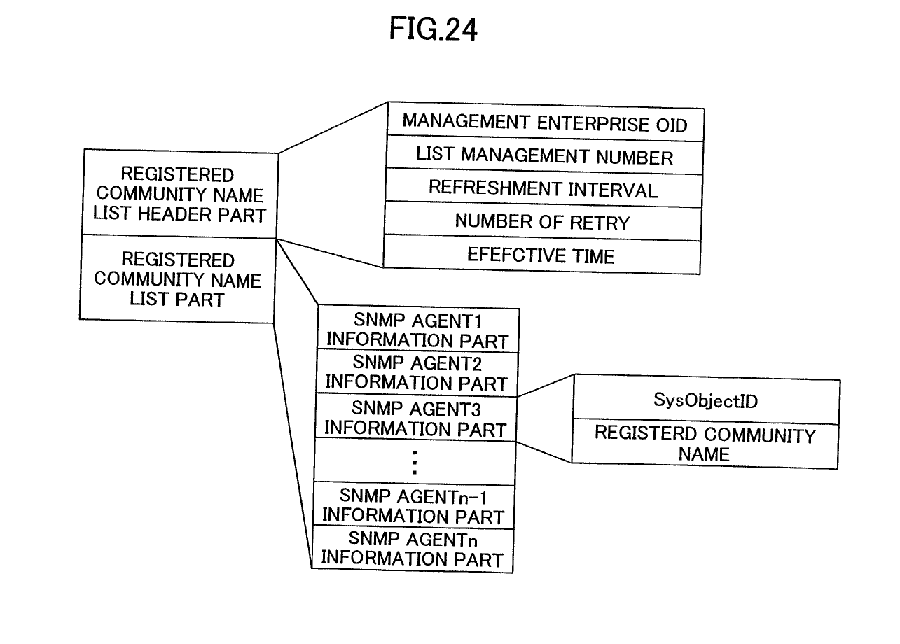

FIG. 24 is an illustration showing a community name list for registration managed by registration community name management server apparatus 86. The community name list for registration consists of a header part and a list part. The header part has OID of the enterprise managed by the list, a list management number which indicates the version of the list information, the refreshment (collation) interval of the server apparatus 86 list information in a case in which a plurality of community name management server apparatuses 86 for registration are operated, and a list effective time of refreshment. The list part consists of SNMP agent management information, and SysObjectID of the SNMP agent apparatus and the community name for registration are stored as a pair. Thus, when adding newly to the network the agent apparatus set as the management object of the manager apparatus, it becomes possible only by connecting the agent apparatus according to the present invention to the network to be managed to treat the agent apparatus concerned as an object to be managed in the system.

Moreover, when newly introducing the manager apparatus according to the present invention into the already managed network, or when replacing a conventional manager apparatus with the manager apparatus according to the present invention, registration of all agent apparatuses becomes possible only by starting the system operation without performing re-registration by manual input of the node management information to be managed or without taking over from the existing manager. Therefore, the running cost of the network is cut down sharply.

Additionally, in order to detect automatically the physical composition of the agent apparatus to be managed in the network and to create a map, an error in a difference between managed data and the physical composition is eliminated. Moreover, whether the number of the agent apparatus for management in a network is increased or reduced, update of a display map is dynamically attained based on the registration from the agent apparatuses. For this reason, a reliable network design can be achieved easily.

Further, since there is a function to limit the range to search automatically, it is not necessary to search an unnecessary domain, thereby, increasing a searching speed. Moreover, the present invention can be applied to a network, which uses each manufacturer's SNMP manager apparatus and SNMP agent apparatus. Moreover, when the registration community name management server apparatus 86 manages the community name for registration on an individual enterprise basis and a system similar to a domain mane service (DSN) which cooperates with a registered community name server apparatus of other manufactures, the registered community name management servers can mutually refer to the registered community name list information.

The present invention is not limited to the specifically disclosed embodiments, and variations and modifications may be made without departing from the scope of the present invention.

The present application is based on Japanese priority application No. 2001-175833 filed on Jun. 11, 2001, the entire contents of which are hereby incorporated by reference.

What is claimed is:

1. A network management method comprising the steps of:
transmitting a message for detection from a manager apparatus to a plurality of agent apparatuses which constitute a network, the message for detection being given a community name for management;
performing automatic detection according to a message for management returned from each agent apparatus, the message for management including management information; and
managing each agent apparatus by said manager apparatus.

2. The network management method as claimed in claim 1, further comprising a step of sending a message for registration of management information from said agent apparatuses to said manager apparatus, the message for registration being given the community name for management.

3. The network management method as claimed in claim 2, further comprising a step of registering and managing the community name for management to be given to the message for registration together with an identifier of each agent apparatus.

4. An agent apparatus constituting a network and being managed by a manager apparatus, comprising:
an automatic detection managing part which receives a message for detection and returns a message for management including management information to said manager apparatus,
wherein the message for detection is given a community name for management which is transmitted from said manager apparatus, and the massage for management is given the community name for management.

5. The agent apparatus as claimed in claim 4, further comprising an automatic registration managing part which transmits a message for registration used for registering management information to said manager apparatus, wherein the message for registration is given the community name for management.

6. A manager apparatus for managing a plurality of agent apparatuses constituting a network, comprising:
an automatic detection managing part which transmits a message for detection to each agent apparatus so as to cause each agent apparatus to return a message for management including management information, wherein the message for detection is given the community name for management.

7. The manager apparatus as claimed in claim 6, further comprising an automatic registration managing part which receives a message for registration transmitted from each agent apparatus and registers the management information included in the message for registration, the massage for registration having the community name for management.

8. The manager apparatus as claimed in claim 7, further comprising a network composition display managing part which receives the message for registration from said agent apparatuses and displays a network composition in accordance with the management information included in the message for registration.

9. The manager apparatus as claimed in claim 8, wherein said network composition display managing part displays the network composition according to a designated display level.

10. The manager apparatus as claimed in claim 6, wherein said automatic detection managing part detects the agent apparatuses within a designated range for searching.

11. The manager apparatus as claimed in claim 10, wherein said automatic detection managing part performs a detection of the agent apparatuses within a designated time period.
